(19) United States
(12) Patent Application Publication
(10) Pub. No.: US 2012/0044214 A1
(43) Pub. Date: Feb. 23, 2012

(54) ELECTRONIC DEVICE ACCESSORY AND METHOD OF PROVIDING THE SAME

(75) Inventor: Kenneth Mori, Los Angeles, CA (US)

(73) Assignee: BELKIN INTERNATIONAL, INC., Playa Vista, CA (US)

(21) Appl. No.: 13/216,067

(22) Filed: Aug. 23, 2011

Related U.S. Application Data
(60) Provisional application No. 61/376,233, filed on Aug. 23, 2010.

(51) Int. Cl. G06F 3/033

(52) U.S. Cl. 345/179

(57) ABSTRACT

Some embodiments include an electronic device accessory. Other embodiments of related electronic device accessories and methods of providing the same are disclosed.

### CROSS-REFERENCE TO RELATED APPLICATIONS

This application claims the benefit of U.S. Provisional Application No. 61/376,233, filed Aug. 23, 2010, the disclosure for which is incorporated herein by reference.

### FIELD OF THE INVENTION

This invention relates generally to an electronic device accessory, and relates more particularly to an electronic device accessory that facilitates communication with and/or operation of an electronic device and methods of providing the same.

### DESCRIPTION OF THE BACKGROUND

Electronic devices, which are continuously condensed into ever smaller form factors, can be difficult to operate because user interfaces (e.g., touch screen displays, etc.) of the electronic devices are reduced in size to correspond to the smaller form factor of the electronic devices. Likewise, where operating the user interfaces of the electronic devices may entail touch communication (e.g., electrically capacitive input, electrically resistive input, etc.), contact between human fingers and the user interfaces can dirty the user interfaces with human sebum, reducing or preventing the ability to view the user interfaces.

Accordingly, a need or potential for benefit exists for a device that facilitates precision communication with and/or operation of an electronic device while preventing transfer of human sebum to a user interface of the electronic device and for methods of providing the same.

### BRIEF DESCRIPTION OF THE DRAWINGS

To facilitate further description of the embodiments, the following drawings are provided in which:

FIG. 1 is a multi-image view illustrating elements and functionality of an exemplary electronic device accessory;

FIG. 2 is an isometric “operational” view detailing the functionality of the exemplary electronic device accessory of FIG. 1;

FIG. 3 is an isometric “operational” view detailing the functionality of the exemplary electronic device accessory of FIG. 1;

FIG. 4 is a side view detailing multiple embodiments of an electronic device accessory, according to another embodiment;

FIG. 5 is a side view detailing multiple embodiments illustrating various configurations of electronic device accessories, according to various embodiments; and

FIG. 6 illustrates a flow chart for an embodiment of a method of providing an electronic device accessory.

For simplicity and clarity of illustration, the drawing figures illustrate the general manner of construction, and descriptions and details of well-known features and techniques may be omitted to avoid unnecessarily obscuring the invention. Additionally, elements in the drawing figures are not necessarily drawn to scale. For example, the dimensions of some of the elements in the figures may be exaggerated relative to other elements to help improve understanding of embodiments of the present invention. The same reference numerals in different figures denote the same elements.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Furthermore, the terms “include,” and “have,” and any variations thereof, are intended to cover a non-exclusive inclusion, such that a process, method, system, article, device, or apparatus that comprises a list of elements is not necessarily limited to those elements, but may include other elements not expressly listed or inherent to such process, method, system, article, device, or apparatus.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments of the invention described herein are, for example, capable of operation in other orientations than those illustrated or otherwise described herein.

The terms “couple,” “coupled,” “couples,” “coupling,” and the like should be broadly understood and refer to connecting two or more elements or signals, electrically, mechanically and/or otherwise. Two or more electrical elements may be electrically coupled together, but not be mechanically or otherwise coupled together; two or more mechanical elements may be mechanically coupled together, but not be electrically or otherwise coupled together; two or more electrical elements may be mechanically coupled together, but not be electrically or otherwise coupled together. Coupling may be for any length of time, e.g., permanent or semi-permanent or only for an instant.

“Electrical coupling” and the like should be broadly understood and include coupling involving any electrical signal, whether a power signal, a data signal, and/or other types or combinations of electrical signals. “Mechanical coupling” and the like should be broadly understood and include mechanical coupling of all types.

The absence of the word “removably,” “removable,” and the like near the word “coupled,” and the like does not mean that the coupling, etc. in question is or is not removable.

The term “mobile electronic device” as used herein refers to at least one of a digital music player, a digital video player, a digital music and video player, a cellular telephone (e.g., smart telephone), a personal digital assistant, a handheld digital computer (e.g., a calculator, a tablet personal computer, a netbook computer, a portable gaming console), or another suitable device configured to output audio and/or visual data. For example, a mobile electronic device can comprise the iPod®, iPhone®, iTouch®, or iPad® product by Apple Inc. of Cupertino, Calif. Likewise, a mobile electronic device can comprise a Blackberry® product by Research in Motion (RIM) of Waterloo, Ontario, Canada, or a different product by a different manufacturer.

### DETAILED DESCRIPTION OF EXAMPLES OF EMBODIMENTS

Some embodiments include a stylus. The stylus comprises a shaft. The shaft comprises a first end and a second end. The stylus also comprises a mass, and the mass comprises a deformable material. The stylus further comprises a skin comprising an inner surface and an outer surface. The mass can be located at the first end of the shaft. At least a first portion of an exterior of the shaft can comprise a first electrically conductive material. At least a first portion of the outer surface of the skin can comprise a second electrically conductive material. The skin can enclose the mass between the inner surface of the skin and the first end of the shaft. The at least the first portion of the outer surface of the skin can be electrically coupled to the at least the first portion of the exterior of the shaft.

Other embodiments include a method of providing a stylus. The method can comprise: providing a shaft comprising a first end and a second end, wherein at least a first portion of an exterior of the shaft comprises a first electrically conductive material; providing a mass at the first end of the shaft, wherein the mass comprises a deformable material; providing a skin comprising an inner surface and an outer surface, wherein at least a first portion of the outer surface of the skin comprises a second electrically conductive material; enclosing the mass within the skin such that the mass is disposed between the inner surface of the skin and the first end of the shaft; and electrically coupling the at least the first portion of the outer surface of the skin to the at least the first portion of the exterior of the shaft.

Still other embodiments include a stylus. The stylus comprises a shaft. The shaft comprises a first end and a second end. The stylus also comprises a mass, and the mass comprises a deformable material. The stylus further comprises a skin comprising an inner surface and an outer surface. The mass can be located at the first end of the shaft. The mass can comprise one of a contiguous mass or multiple constituent sub-masses. The deformable material can comprise at least one of rubber, foam rubber, soft plastic, or sand. The at least a first portion of an exterior of the shaft can comprise a first electrically conductive material. The first electrically conductive material can comprise at least one of copper, silver, gold, aluminum, tungsten, nickel, iron, carbon, or tin. At least a first portion of the outer surface of the skin can comprises a second electrically conductive material. The second electrically conductive material can comprise at least one of copper, silver, gold, aluminum, tungsten, nickel, iron, carbon, or tin. The skin can comprise at least one of rubber, stretchy fabric, or foam rubber. The skin can enclose the mass between the inner surface of the skin and the first end of the shaft. The at least the first portion of the outer surface of the skin can be electrically coupled to the at least the first portion of the exterior of the shaft. The stylus can be configured such that when the skin of the stylus contacts a surface of a mobile electronic device, the surface of the electronic device being configured to receive at least one of an electrically capacitive input or an electrically resistive input, the skin and the shaft electrically couple a hand of a user to the surface.

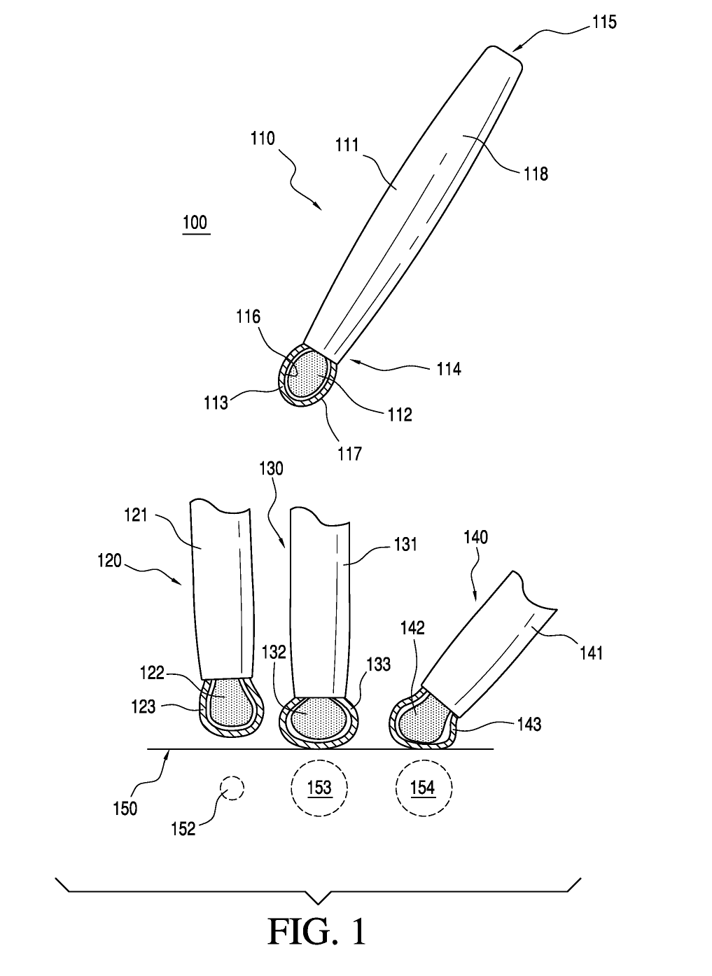

Turning to the drawings, FIG. 1 is a multi-image view 100 that illustrates the elements as well as the functionality of an exemplary electronic device accessory 110. Electronic device accessory 110 can be configured to facilitate precision communication with and/or operation of an electronic device comprising user interface 150 (e.g., a touch screen surface) while preventing transfer of human sebum to user interface 150. In some embodiments, electronic device accessory 110 can be referred to as a stylus. The electronic device can comprise any suitable electronic device comprising user interface 150, but in many embodiments, the electronic device comprises a mobile electronic device. Meanwhile, user interface 150 can be implemented as any suitable touch screen surface, such as, for example a capacitive touch screen surface, a resistive touch screen surface, a combination resistive/capacitive touch screen surface, and the like.

Electronic device accessory 110 comprises shaft 111. Shaft 111 can comprise first end 114, second end 115, and exterior 118. Electronic device accessory 110 further comprises mass 112 and skin 113. Skin 113 can comprise inner surface 116 and/or outer surface 117.

The term “shaft” is used for convenience of reference and should not be interpreted as limiting. Accordingly, shaft 111 can be any suitably shaped body functioning similarly to shaft 111, as described below.

At least a first portion and/or all of exterior 118 of shaft 111 can comprise a first electrically conductive material. For example, the first electrically conductive material can comprise copper, silver, gold, aluminum, tungsten, nickel, iron, carbon, and/or tin. In one embodiment, if only a portion (e.g., the first portion) of exterior 118 of shaft 111 is electrically conductive, then the portion can contact a user's hand when the user operates electronic device accessory 110. In some embodiments, at least a second portion of exterior 118 of shaft 111 comprises a non-electrically conductive material. For example, the non-electrically conductive material can comprise wood, plastic, non-ferrous metal, and/or glass.

Meanwhile, at least first portion and/or all of outer surface 117 of skin 113 can comprise a second electrically conductive material. The second electrically conductive material can be similar or identical to the first electrically conductive material or in other embodiments, may be different from the first electrically conductive material. Accordingly, the second electrically conductive material can comprise copper, silver, gold, aluminum, tungsten, nickel, iron, carbon, and/or tin.

In many embodiments, the first portion and/or all of outer surface 117 of skin 113 can be electrically coupled to the first portion and/or all of exterior 118 of shaft 111. Accordingly, as expanded upon below, electronic device accessory 110 can be configured such that when the electrically conductive portion of skin 113 contacts user interface 150 of an electronic device, the electrically conductive portion of skin 113 and shaft 111 electrically couple a hand of a user to user interface 150. As a result, the user can communicate with and/or operate the electronic device via user interface 150 using electronic device accessory 110.

Mass 112 can be located at first end 114 of shaft 111. For example, mass 112 can be configured to abut first end 114 of shaft 111. Accordingly, by abutting first end 114 of shaft 111, mass 112 can provide a desired “feel” to a user when the user is operating electronic device accessory 110 in conjunction with an electronic device. The referenced “feel” can be similar or identical to the feeling of using a writing implement (e.g., a pen, a pencil, etc.).

Mass 112 can comprise a deformable material. For example, the deformable material comprises at least one of rubber, foam rubber, soft plastic, a pressurized gas, or sand. In these embodiments, soft plastic can refer to plastics having a Shore A durometer between 0-80. In some embodiments, mass 112 can comprise a contiguous mass and/or multiple constituent sub-masses (e.g., sand). Accordingly, mass 112 can be configured to deform and/or to be deformed. In many embodiments, mass 112 can be deformed as a result of force being applied to mass 112, such as, when electronic device accessory 110 and/or skin 113 are being pushed against user interface 150.

Meanwhile, skin 113 can enclose and/or can be configured to enclose mass 112 at and/or between inner surface 116 and first end 114 of shaft 111. Thus, skin 113 can secure and/or can be configured to secure mass 112 to shaft 111 and/or first end 114. In some embodiments, skin 113 can secure and/or can be configured to secure mass 112 within and/or partially within an interior of shaft 111.

In various embodiments, skin 113 can enable and/or can be configured to permit mass 112 to deform from one shape to another shape when skin 113 is enclosing mass 112 at and/or between inner surface 116 and first end 114 of shaft 111. Accordingly, skin 113 can comprise rubber, biaxially-oriented polyethylene terephthalate, fabric (e.g., nylon and/or spandex), foam rubber, and/or any other material suitably configured to permit mass 112 to deform from one shape to another. Although a gap is shown in FIG. 1 between mass 112 and inner surface 116, the gap may be omitted from electronic device accessory 110.

Meanwhile, skin 113 can also comprise the second electrically conductive material, as described above with respect to outer surface 117 of skin 113. Nonetheless, skin 113 also can prevent and/or can be configured to prevent mass 112 from separating from shaft 111, particularly where mass 112 comprises multiple constituent sub-masses (e.g., sand), as described above.

In still other embodiments, skin 113 can enable and/or can be configured to enable electronic device accessory 110 to glide (e.g., smoothly) across user interface 150 of the electronic device. Accordingly, outer surface 117 of skin 113 can comprise a low coefficient of friction (e.g., less than or equal to approximately 0.5, 0.7, and/or 0.9).

In some embodiments, skin 113 can be configured to be replaceable with another skin. In these embodiments, skin 113 can be replaced where the other skin(s) may more optimally glide across user interface 150. Likewise, skin 113 can be replaced where skin 113 has worn out from use.

Multi-image view 100 additionally illustrates electronic device accessories 120, 130, and 140. Electronic devices accessories 120, 130, and/or 140 can be similar or identical to electronic device accessory 110. Electronic device accessories 120, 130, and/or 140 further detail the interaction of mobile device accessory 110 with user interface 150.

Accordingly, electronic device accessory 120 includes shaft 121, mass 122 and skin 123. Meanwhile, electronic device accessory 130 comprises shaft 131, mass 132, and skin 133. Likewise, electronic device accessory 140 comprises shaft 141, mass 142, and skin 143. Shaft 121, shaft 131, and/or shaft 141 can be similar or identical to shaft 111. Mass 122, mass 132, and/or mass 142 can be similar or identical to mass 112. Skin 123, skin 133, and/or skin 143 can be similar or identical to skin 113.

Mobile device accessory 120, as well as user interface 150 and associated minimum contact area 152 illustrate what occurs as any of electronic device accessories 110, 120, 130, and/or 140 approach user interface 150. Electronic device accessory 130, as well as user interface 150 and associated minimum contact area 153 illustrate any of electronic device accessories 110, 120, 130, and/or 140 performing in the manner of a conventional stylus interacting with user interface 150. Mobile device accessory 140 as well as user interface 150 and associated minimum contact area 154 illustrate that a more natural drawing position can be advantageously achieved when utilizing any of electronic device accessories 110, 120, 130, and/or 140 and interacting with user interface 150 while still maintaining associated minimum contact area 154. A conventional stylus cannot be effectively operated in this manner, and/or the portion of a conventional stylus that contacts user interface 150 cannot deform in the manner of electronic device access 140. Minimum contact area 154 can be similar or identical to minimum contact area 153. The phrase “minimum contact area” can reference a sufficient surface area of contact between skin 113 and user interface 150 to establish an effective electrical coupling between skin 113 and user interface 150.

In many embodiments, shaft 111, shaft 121, shaft 131, and/or shaft 141 can comprise a cross-section. In some embodiments, the cross-section can comprises at least one of a circle, an oval, or a polygon. In the same or different embodiments, the cross-section further comprises an area. In the same or different embodiments, the area is constant along the shaft. In other embodiments, the area is not constant along the shaft. In many embodiments, shaft 111, shaft 121, shaft 131, and/or shaft 141 can comprise a hollow center.

In some embodiments, electronic device accessory 110 and/or second end 115 can comprise a clip mechanism. The clip mechanism can be configured to couple electronic device accessory 110 to an object (e.g., one or more pieces of paper, a shirt collar, etc.). The clip mechanism can be similar or identical to any suitable clipping mechanism of a writing implement, such as, a pen.

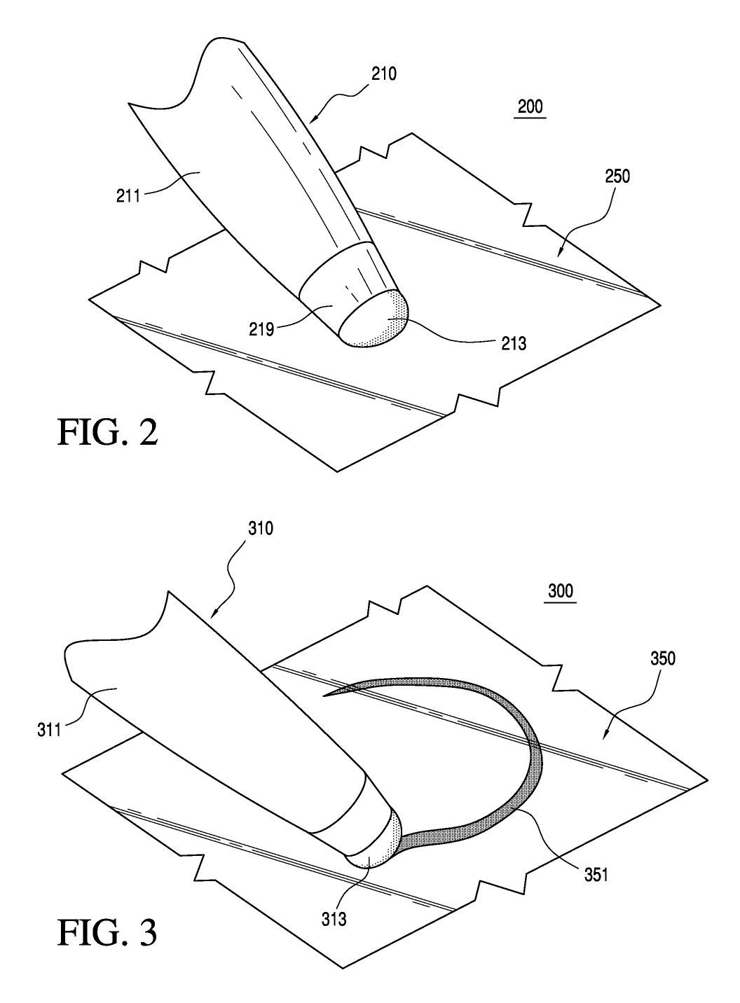

FIG. 2 is an isometric “operational” view 200 detailing the functionality of the exemplary electronic device accessory 110 (FIG. 1). Isometric “operational” view 200 details the interaction of electronic device accessory 210 with user interface 250. Electronic device accessory 210 can be similar or identical to electronic device accessory 110 (FIG. 1), and/or user interface 250 can be similar or identical to user interface 150 (FIG. 1). For example, electronic device accessory 210 can comprise shaft 211, a mass (not shown), and skin 213, each of which can be similar or identical to shaft 111 (FIG. 1), mass 112 (FIG. 1), and skin 113 (FIG. 1), respectively. Mobile device accessory 210 can comprise ring or collar 219 to mechanically and electrically couple skin 213 to shaft 211. In FIG. 2, electronic device accessory 210 is contacting user interface 250. In some embodiments, electronic device accessory 210 is contacting user interface 250 as illustrated by mobile device accessory 140 (FIG. 1) and associated minimum contact area 154 (FIG. 1). In other embodiments, electronic device accessory 210 is contacting user interface 250 prior to a user drawing on touch screen surface 250 with mobile device accessory 210.

FIG. 3 is an isometric “operational” view 300 detailing the functionality of the exemplary electronic device accessory 110 (FIG. 1). Isometric “operational” view 300 details the interaction of electronic device accessory 310 with user interface 350. Electronic device accessory 310 can be similar or identical to electronic device accessory 110 (FIG. 1), and/or user interface 350 can be similar or identical to user interface 150 (FIG. 1). For example, electronic device accessory 310 can comprise shaft 311, a mass (not shown), and skin 313, each of which can be similar or identical to shaft 111 (FIG. 1), mass 112 (FIG. 1), and skin 113 (FIG. 1), respectively. In FIG. 3, electronic device accessory 310 is contacting user interface 350 and moving along the surface of user interface 350 to create line 351 at user interface 350. In some embodiments, electronic device accessory 310 is contacting user interface 350, as illustrated by electronic device accessory 140 (FIG. 1) and associated minimum contact area 154 (FIG. 1), and is moving along the surface of touch screen surface 350 to provide line 351.

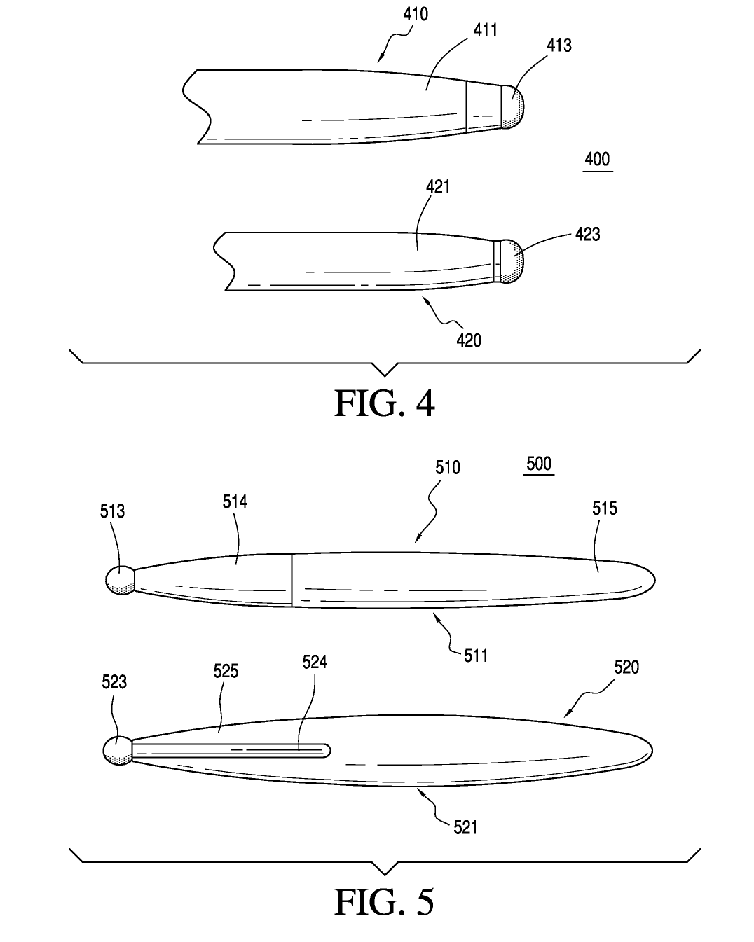

FIG. 4 is a side view 400 detailing multiple embodiments of an electronic device accessory. Side view 400 illustrates electronic device accessories 410 and 420. Electronic device accessories 410 and/or 420 can be similar to electronic device accessory 110 (FIG. 1). Electronic device accessory 410 can comprise shaft 411, a mass (not shown), and skin 413, each of which can be similar or identical to shaft 111 (FIG. 1), mass 112 (FIG. 1), and skin 113 (FIG. 1), respectively. Meanwhile, electronic device accessory 420 can comprise shaft 421, a mass (not shown), and skin 423, each of which can be similar or identical to shaft 111 (FIG. 1), mass 112 (FIG. 1), and skin 113 (FIG. 1), respectively. View 400 illustrates different types of writing implements that can incorporate the embodiments described herein.

FIG. 5 is a side view 500 detailing multiple embodiments illustrating various configurations of electronic device accessories. View 500 illustrates electronic device accessories 510 and 520. Electronic device accessories 510 and/or 520 can be similar or identical to electronic device accessory 110 (FIG. 1). Electronic device accessory 510 can comprise shaft 511 comprising conductive portion 514 and non-conductive portion 515, a mass (not shown), and skin 513. Shaft 511 can be similar of identical to shaft 111 (FIG. 1); the mass can be similar or identical to mass 112 (FIG. 1); and/or skin 513 can be similar or identical to skin 113 (FIG. 1). Meanwhile, electronic device accessory 520 comprises shaft 521 comprising conductive portion 524 and non-conductive portion 525, a mass (not shown), and skin 523. Shaft 521 can be similar of identical to shaft 111 (FIG. 1); the mass can be similar or identical to mass 112 (FIG. 1); and/or skin 523 can be similar or identical to skin 113 (FIG. 1). Accordingly, in some embodiments and as described above, electronic device accessory 510 can be manufactured so that only the lower portion comprises conductive materials. In other embodiments, electronic device accessory 520 can be manufactured so that only a small portion of shaft 521 comprises conductive materials. View 500 illustrates two of the many ways to manufacture embodiments of shaft 111, 121, 131, 141, 211, 311, 411, 421, 511, and/or 521, such as, for example to reduce material costs, enhance sustainability, and the like.

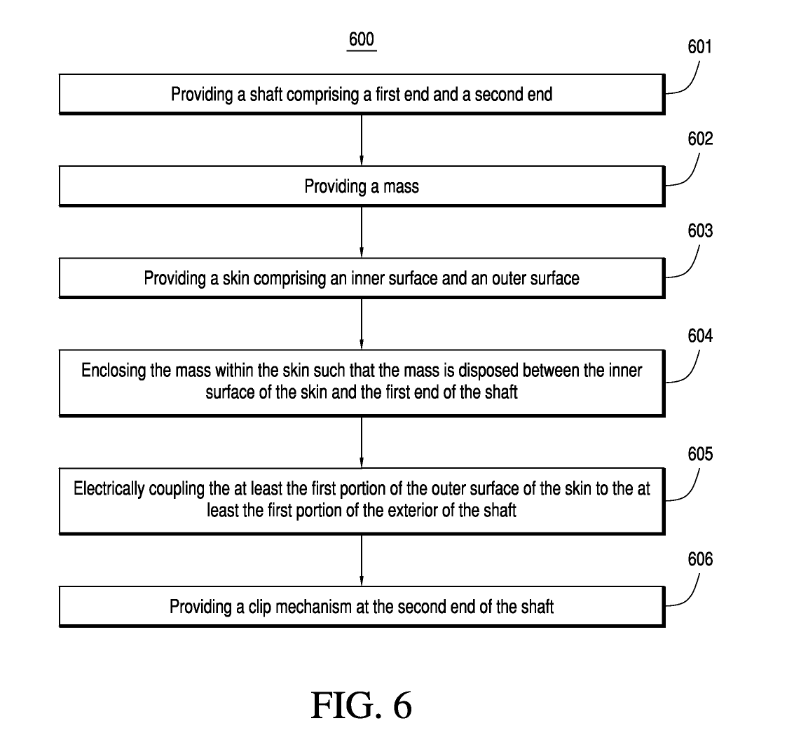

FIG. 6 illustrates a flow chart for an embodiment of a method 600 of providing an electronic device accessory. Method 600 is merely exemplary and is not limited to the embodiments presented herein. Method 600 can be employed in many different embodiments or examples not specifically depicted or described herein. In some embodiments, the procedures, the processes, and/or the activities of method 600 can be performed in the order presented. In other embodiments, the procedures, the processes, and/or the activities of the method 600 can be performed in any other suitable order. In still other embodiments, one or more of the procedures, the processes, and/or the activities in method 600 can be combined or skipped.

Referring now to FIG. 6, method 600 can comprise procedure 601 of providing a shaft comprising a first end and a second end. The shaft can be similar or identical to shaft 111 (FIG. 1). The first end can be similar or identical to first end 114 (FIG. 1), and/or the second end can be similar or identical to second end 115 (FIG. 1).

Method 600 can comprise procedure 602 providing a mass. Procedure 602 can comprise providing the mass at the first end of the shaft. The mass can be similar or identical to mass 112 (FIG. 1).

Method 600 can comprise procedure 603 of providing a skin comprising an inner surface and an outer surface. The skin can be similar or identical to skin 113 (FIG. 1). The inner surface can be similar or identical to inner surface 116 (FIG. 1), and/or the outer surface can be similar or identical to outer surface 117 (FIG. 1).

Method 600 can comprise procedure 604 of enclosing the mass within the skin such that the mass is disposed between the inner surface of the skin and the first end of the shaft. Procedure 604 can be performed after procedure 601, procedure 602, and/or procedure 603.

Method 600 can comprise procedure 605 of electrically coupling the at least the first portion of the outer surface of the skin to the at least the first portion of the exterior of the shaft. Procedure 605 can be performed simultaneously with and/or after one or more of procedures 601-604.

Method 600 can comprise procedure 606 of providing a clip mechanism at the second end of the shaft. The clip mechanism can be similar or identical to the clip mechanism described above with respect to electronic device accessory 110 (FIG. 1). Procedure 606 can be performed after one or more of procedures 601-605.

Although the invention has been described with reference to specific embodiments, it will be understood by those skilled in the art that various changes may be made without departing from the spirit or scope of the invention. Accordingly, the disclosure of embodiments of the invention is intended to be illustrative of the scope of the invention and is not intended to be limiting. It is intended that the scope of the invention shall be limited only to the extent required by the appended claims. For example, to one of ordinary skill in the art, it will be readily apparent that procedures 601-606 (FIG. 6) may be comprised of many different procedures, processes, and activities and be performed by many different modules, in many different orders, that any element of FIGS. 1-6 may be modified, and that the foregoing discussion of certain of these embodiments does not necessarily represent a complete description of all possible embodiments.

All elements claimed in any particular claim are essential to the embodiment claimed in that particular claim. Consequently, replacement of one or more claimed elements constitutes reconstruction and not repair. Additionally, benefits, other advantages, and solutions to problems have been described with regard to specific embodiments. The benefits, advantages, solutions to problems, and any element or elements that may cause any benefit, advantage, or solution to occur or become more pronounced, however, are not to be construed as critical, required, or essential features or elements of any or all of the claims, unless such benefits, advantages, solutions, or elements are expressly stated in such claim.

Moreover, embodiments and limitations disclosed herein are not dedicated to the public under the doctrine of dedication if the embodiments and/or limitations: (1) are not expressly claimed in the claims; and (2) are or are potentially equivalents of express elements and/or limitations in the claims under the doctrine of equivalents.

What is claimed is:

1) A stylus comprising:
a shaft comprising a first end and a second end;
a mass comprising a deformable material; and
a skin comprising an inner surface and an outer surface;
wherein:
the mass is located at the first end of the shaft;
at least a first portion of an exterior of the shaft comprises a first electrically conductive material;
at least a first portion of the outer surface of the skin comprises a second electrically conductive material;
the skin encloses the mass between the inner surface of the skin and the first end of the shaft; and
the at least the first portion of the outer surface of the skin is electrically coupled to the at least the first portion of the exterior of the shaft.

2) The stylus of claim 1 wherein:
the first electrically conductive material comprises at least one of copper, silver, gold, aluminum, tungsten, nickel, iron, carbon, or tin.

3) The stylus of claim 1 wherein:
all of the exterior of the shaft comprises the first electrically conductive material.

4) The stylus of claim 1 wherein:
at least a second portion of the exterior of the shaft comprises a non-electrically conductive material.

5) The stylus of claim 4 wherein:
the non-electrically conductive material comprises at least one of wood, plastic, non-ferrous metal, or glass.

6) The stylus of claim 1 wherein:
the deformable material comprises at least one of rubber, foam rubber, soft plastic, or sand.

7) The stylus of claim 1 wherein:
the mass comprises one of a contiguous mass or multiple constituent sub-masses.

8) The stylus of claim 1 wherein:
the skin comprises at least one of rubber, fabric, or foam rubber.

9) The stylus of claim 1 wherein:
the second electrically conductive material comprises at least one of copper, silver, gold, aluminum, tungsten, nickel, iron, carbon, or tin.

10) The stylus of claim 1 wherein:
the second electrically conductive material comprises a coefficient of friction less than or equal to approximately 0.7.

11) The stylus of claim 1 wherein:
all of the outer surface of the skin comprises the second electrically conductive material.

12) The stylus of claim 1 wherein:
the second end comprises a clip mechanism; and
the clip mechanism is configured to couple the stylus to an object.

13) The stylus of claim 1 wherein:
the stylus is configured such that when the skin of the stylus contacts a surface of an electronic device, the surface of the electronic device being configured to receive at least one of an electrically capacitive input or an electrically resistive input, the skin and the shaft electrically couple a hand of a user to the surface.

14) A method of providing a stylus, the method comprising:
providing a shaft comprising a first end and a second end, wherein at least a first portion of an exterior of the shaft comprises a first electrically conductive material;
providing a mass at the first end of the shaft, wherein the mass comprises a deformable material;
providing a skin comprising an inner surface and an outer surface, wherein at least a first portion of the outer surface of the skin comprises a second electrically conductive material;
enclosing the mass within the skin such that the mass is disposed between the inner surface of the skin and the first end of the shaft; and
electrically coupling the at least the first portion of the outer surface of the skin to the at least the first portion of the exterior of the shaft.

15) The method of claim 14 wherein: the first electrically conductive material comprises at least one of copper, silver, gold, aluminum, tungsten, nickel, iron, carbon, or tin.

16) The method of claim 14 wherein:
all of the exterior of the shaft comprises the first electrically conductive material.

17) The method of claim 14 wherein:
at least a second portion of the exterior of the shaft comprises a non-electrically conductive material.

18) The method of claim 17 wherein:
the non-electrically conductive material comprises at least one of wood, plastic, non-ferrous metal, or glass.

19) The method of claim 14 wherein:
the deformable material comprises at least one of rubber, foam rubber, soft plastic, or sand.

20) The method of claim 14 wherein:
the mass comprises one of a contiguous mass or multiple constituent sub-masses.

21) The method of claim 14 wherein:
the skin comprises at least one of rubber, fabric, or foam rubber.

22) The method of claim 14 wherein:
the second electrically conductive material comprises at least one of copper, silver, gold, aluminum, tungsten, nickel, iron, carbon, or tin.

23) The method of claim 14 wherein:
the second electrically conductive material comprises a coefficient of friction less than or equal to approximately 0.7.

24) The method of claim 14 wherein:
all of the outer surface of the skin comprises the second electrically conductive material.

25) The method of claim 14 wherein:
providing a clip mechanism at the second end of the shaft, wherein the clip mechanism is configured to couple the stylus to an object.

26) The method of claim 14 wherein:
the stylus is configured such that when the skin of the stylus contacts a surface of an electronic device, the surface of the electronic device being configured to receive at least one of an electrically capacitive input or an electrically resistive input, the skin and the shaft electrically couple a hand of a user to the surface.

27) A stylus comprising:
a shaft comprising a first end and a second end;
a mass comprising a deformable material; and
a skin comprising an inner surface and an outer surface;
wherein:
the mass is located at the first end of the shaft;
the mass comprises one of a contiguous mass or multiple constituent sub-masses;
the deformable material comprises at least one of rubber, foam rubber, soft plastic, or sand;
at least a first portion of an exterior of the shaft comprises a first electrically conductive material;
the first electrically conductive material comprises at least one of copper, silver, gold, aluminum, tungsten, nickel, iron, carbon, or tin;
at least a first portion of the outer surface of the skin comprises a second electrically conductive material;
the second electrically conductive material comprises at least one of copper, silver, gold, aluminum, tungsten, nickel, iron, carbon, or tin;
the skin comprises at least one of rubber, fabric, or foam rubber;
the skin encloses the mass between the inner surface of the skin and the first end of the shaft;
the at least the first portion of the outer surface of the skin is electrically coupled to the at least the first portion of the exterior of the shaft; and
the stylus is configured such that when the skin of the stylus contacts a surface of a mobile electronic device, the surface of the electronic device being configured to receive at least one of an electrically capacitive input or an electrically resistive input, the skin and the shaft electrically couple a hand of a user to the surface.
